(19) United States
(12) Patent Application Publication
(10) Pub. No.: US 2018/0326674 A1
(43) Pub. Date: Nov. 15, 2018

(54) JOINTED MEMBER AND METHOD OF JOINING

(71) Applicant: GM GLOBAL TECHNOLOGY OPERATIONS LLC, Detroit, MI (US)

(72) Inventors: David Yang, Shanghai (CN); Jing Zhang, Shanghai (CN); Jiguo Shan, Beijing (CN); Xianghu Tan, Beijing (CN)

(73) Assignee: GM GLOBAL TECHNOLOGY OPERATIONS LLC, Detroit, MI (US)

(21) Appl. No.: 15/771,173

(22) PCT Filed: Dec. 17, 2015
(86) PCT No.: PCT/CN2015/097722

§ 371 Date: Apr. 27, 2018

(51) Int. Cl. B29C 65/00; B29C 65/44; B29C 65/82

(52) U.S. Cl. CPC B29C 66/9192; B29C 65/44; B29C 65/8215; B29C 66/0342; B32B 7/04; B29C 66/30321; B29C 66/347; B29C 66/45; B29C 66/83221; B29C 66/1122

(57) ABSTRACT

A joint member (100) includes a metal component (12) and a composite component (14) which are joined by a joint (10) formed at a non-planar joint interface (18) defined by a textured surface portion (28) of the metal component (12) and a solidified melted area (24) of the composite component (14). The solidified melted area (24) adjacent to the joint interface (18) is characterized by a plurality of non-contiguous solidification boundaries (22) and a non-contiguous dispersion of porosity (16). A method includes forming a textured surface portion (28) on the metal component (12), pressing the textured surface portion (28) into the surface of the composite component (14) to form depressions (32) in the composite component (14), such that a joint interface (18) is defined by the surfaces of the textured surface portion (28) and the composite depressions (32), heating the joint interface (18) to melt an area of the composite component (14) adjacent to the joint interface (18), and solidifying the melted area (24) to the form a joint (10) at the joint interface (18).

### TECHNICAL FIELD

The present disclosure relates generally to a jointed member formed by joining metal and composite components and a method for joining metal and composite components.

### BACKGROUND

The use of composite materials such as fiber-reinforced polymer (FRP), which is non-corroding and has a high strength-to-weight ratio and relatively higher fatigue resistance compared with metallic materials is rapidly increasing in aircraft and automobiles, where weight savings is desired. Joining of FRP and metal is necessary in many applications. Adhesive bonding and mechanical joining using mechanical fasteners such as bolts or self-piercing rivets are common methods for joining FRP and metal. However, bolt joining usually requires pre-drilling and manual fastening, which is inefficient, costly, and increases weight. Adhesive joining requires surface treatment before joining, which is costly, and a long cure process, which is inefficient. Adhesive bonded joints formed between FRP and metal can have a relatively low strength.

Joining of the composite material and metal can be performed using various fusion welding processes, such as ultrasonic welding, resistance spot welding, arc welding, laser welding, etc. For example, FIGS. 1, 2, 3, 9, 10 and 13 illustrate features and characteristics of a joint 10A of a jointed member 100A consisting of a metal component 12A and a composite component 14A, where the joint 10A is formed between the composite component 14A and the metal component 12A at a generally planar, e.g., a generally flat, joint interface 18A using laser joining. The composite component 12A can be made of FRP consisting of a polymer matrix 34A and reinforced fibers 36A. The joint 10A includes a generally planar metal surface portion 38A of the metal component 12A bonded to an interface surface portion 40A of the composite component 14A to form the generally planar, e.g., generally flat, joint interface 18A.

During formation of the joint 10A, a directed heat source such as a laser is used to heat the metal component 12A, forming a heated zone 20 including the planar, e.g., generally flat, metal surface 38A of the metal component 12A, such that heat is conducted via the generally planar joint interface 18A to the interface surface portion 40A of the composite component 14A causing melting of the composite material in a melted zone 24A of the composite component 14A, including melting in a rim portion 58A adjacent to the joint interface 18A. The composite material decomposes under heating, causing ablation of the polymer matrix material 34A in the melted zone 24A, and entrapment of gas released during ablation in the melted matrix material 34A. During cooling of the melted zone 24A, heat is conducted from the joint interface 18A in a regular heat conduction pattern 52A which is generally perpendicular to the planar joint interface 18A, such that the melted composite solidifies initially at the joint interface 18A. Because of the high thermal conductivity of the metal component 12A, shrinkage porosity 16A is easily formed at the rim portion 58A and porosity 16A forms at the joint interface 18A from the gas entrapped at the joint interface 18A. Heat continues to be conducted away from the joint interface 18A via the metal component 12A until a last solidification boundary 22A, which defines a generally continuous and concave or bowl-shaped boundary, forms at the location where the last of the melted matrix material 34A in the melted zone 24A is solidified. During solidification of the melted zone 24A, entrapped gas remains in, e.g., migrates through, the melted zone 24A until the last solidification of the melted material occurs, where the entrapped gas is surrounded by solidified material to form porosity 16A along the continuous and generally bowl-shaped solidification boundary 22A, and shrinkage porosity 16A is formed at the rim portion 58A.A “last solidification boundary,” as that term is used herein, is the location at which the last of the melted material solidifies, thus forming a boundary between previously solidified material and the last solidified material. A “last solidification boundary” may be referred to herein as a “solidification boundary.” The metallographic image shown in FIG. 1 and a portion of which is magnified in FIG. 2, shows the porosity 16A, consisting of a plurality of pores 26A, is concentrated along the continuous solidification boundary 22A such that the effective cross-sectional area of the joint 10A along the continuous solidification boundary 22A is substantially decreased due to the concentration of pores 26A. Under a loaded condition, for example, during tensile shear testing, the shear strength S_{A} and elongation E_{A} performance (see FIG. 13) of the joint 10A is limited by the decrease in the effective cross-sectional area of the joint 10A due to the porosity 16A, and by the tendency for crack initiation at the rim portion 58A of the joint 10A and crack propagation from pore to pore 26A along the continuous solidification boundary 22A.

### SUMMARY

A method for joining metal and composite components and a jointed member formed by joining metal and composite components are disclosed herein. The metal-composite joint formed by the method disclosed herein is formed at a non-planar joint interface defined by a textured surface portion of the metal component and includes a solidified melted zone which is characterized by a plurality of non-continuous solidification boundaries and a discontinuous distribution of porosity. Due to the relatively larger surface area of the non-planar joint interface and the irregular heat conduction path through the non-planar joint interface, melting of the composite material is performed more efficiently, e.g., in less time, and with less decomposition of the matrix material, resulting in a smaller volume of entrapped gas, and a porosity distribution characterized by fewer and smaller pores more randomly dispersed in the solidified melted material, relative to the joint 10A illustrated by FIGS. 1-3 having a generally planar joint interface. The irregular heat conduction pattern through the non-planar joint interface causes formation of multiple discontinuous solidification boundaries within the joint. As such, the effective cross-sectional area of the joint formed with a non-planar joint interface is greater than that formed in a joint having a generally planar joint interface, and the propensity for crack propagation is reduced due to the absence of a continuous solidification boundary, the formation of multiple discontinuous solidification boundaries, and the random distribution of relatively smaller pores in the solidified melted zone adjacent to the non-planar joint interface. Under a loaded condition, for example, during tensile shear testing, crack propagation is suppressed and/or interrupted due to protuberances protruding from the textured surface portion into the solidified melted zone, the formation of multiple and discontinuous solidification boundaries, and a discontinuous pattern of porosity, such that the shear strength S_{T} and elongation E_{T} performance of the joint formed at the non-planar joint interface by the method disclosed herein is relatively greater than the shear strength S_{A} and elongation E_{A} performance of the joint 10A having a generally planar joint interface.

The jointed member disclosed herein includes a metal component having a metal surface including a textured surface portion and a composite component having an interface surface portion. The composite component can be comprised of a polymer matrix in which a filler material is dispersed. In one example, the composite component is a carbon fiber-reinforced polymer (CFRP). The textured surface portion includes a plurality of protuberances protruding from the metal surface which protrude into the interface surface portion to define a non-planar joint interface. The protuberances can be irregular in shape. The joint is formed by heating the metal and composite components at the joint interface to form a melted area in the composite material adjacent to the joint interface, such that after cooling the solidified melted area conforms to and is bonded to the textured surface portion to form the joint. Heat transfer in an irregular heat conduction pattern across the non-planar joint interface during cooling causes porosity in the form of a plurality of pores distributed in a relatively non-continuous pattern and a plurality of discontinuous solidification boundaries to form in the solidified melted zone. A solidification boundary, as that term is referred to herein, is formed at and/or identifies the last solidification location at which melted material solidifies during solidification of the melted zone. The shape, size, and configuration of a solidification boundary, and the frequency and/or distribution pattern of solidification boundaries in a solidified melted zone are determined to a large extent by the heat conduction pattern which occurs during heating of the joint interface portion of the composite component to form the melted zone, and by the heat conduction pattern which occurs during cooling of the melted zone to form a solidified melted zone. The discontinuity of the solidification boundaries, the protuberances, the non-continuous pattern of porosity, and relatively fewer pores act to suppress or interrupt crack propagation through the joint during loading of the joint, contributing to a higher tensile shear strength S_{T} and elongation E_{T} of the joint relative to the joint 10A shown in FIGS. 1-3 including a generally planar interface.

A method of forming a jointed member by forming a joint between a metal component and a composite component includes texturing a metal surface of the metal component to form a plurality of protuberances. In one example, the texturing is performed using a laser. The protuberances can be irregular or asymmetrical in shape, and can vary in height, size, and configuration from one another. In another example, the protuberances can be of a uniform size and shape. The method further includes pressing the textured surface portion in contact with an interface surface portion of the composite component, such that the textured surface portion protrudes into the interface surface portion to form a non-planar joint interface defined by the textured surface portion. In one example, the textured surface portion is pressed into the interface surface portion of the composite component such that the plurality of protuberances form a plurality of depressions in the interface surface portion, and such that the non-planar joint interface formed thereby is defined by the plurality of protuberances and the plurality of depressions.

The method further includes forming a joint at the non-planar joint interface between the metal component and the composite component by heating the joint interface above a critical temperature to form a melted zone in the interface surface portion immediately adjacent the joint interface. Heating of the joint interface can include directing a non-contact heat source such as a laser at an exterior surface of the metal component, such that heat is conducted through the metal component and via the textured surface portion and joint interface in an irregular conduction pattern to the interface surface portion to heat the joint interface above the critical temperature. After heating, the metal and composite components are cooled to solidify the melted zone, thus bonding the melted zone to the textured surface portion to form a bonded joint. Cooling occurs by conducting heat away from the non-planar joint interface and the melted zone in an irregular heat conduction pattern defined by the textured surface portion. During solidification of the melted zone, a plurality of discontinuous solidification boundaries are formed in the solidified melted zone, where each respective solidification boundary is determined by a respective location of last solidification of melted composite in the melted zone. The discontinuity of the solidification boundaries and protuberances intermediate the solidification boundaries act to suppress or interrupt crack propagation through the joint during loading of the joint, contributing to a relatively higher tensile shear strength and elongation of the joint.

During cooling of the melted zone, solidified composite material surrounds the entrapped gas such that the entrapped gas forms a plurality of pores to produce a relatively discontinuous pattern of porosity in the solidified melted zone, where the discontinuity of the pattern of porosity is to a large extent determined by the heat conduction pattern across the non-planar interface, the profile of the textured surface portion, and the formation of a plurality of solidification boundaries in the solidified melted portion. In the example shown, the plurality of pores can include pores distributed in the solidified melted zone such that one or more pores are separated from at least another pore by a protuberance, such that crack propagation between respective pores can be interrupted by the respective protuberance intermediate the pores, reducing the propensity for crack propagation through the discontinuous porosity pattern of the joint, and contributing to a relatively higher tensile shear strength and relative greater elongation of the joint.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a metallographic image of a cross-section of a joint formed at a planar interface between a composite sheet and a metal sheet using laser joining;

FIG. 2 is a metallographic image of a portion of area 2 of the joint of FIG. 1 at a higher magnification;

FIG. 3 is schematic illustration of area 2 of the cross-section of the joint shown in FIG. 1;

FIG. 4 is a metallographic image of a cross-section of a joint formed at a non-planar interface between a composite component and a metal component using laser joining;

FIG. 5 is a metallographic image of area 5 of the joint of FIG. 4 at a higher magnification;

FIG. 6 is a metallographic image of a textured surface portion of the surface of the metal component of FIG. 4;

FIG. 7 is a metallographic image of area 7 of the textured surface portion shown in FIG. 6, at a higher magnification and showing a protuberance formed in the textured surface portion;

FIG. 8 is a schematic illustration of area 5 of the cross-section of the joint of FIG. 4;

FIG. 9 is a thermographic image of a temperature distribution field of a heat conduction pattern at the initial heating stage of laser joining of the joint of FIG. 1;

FIG. 10 is a thermographic image of a temperature distribution field of a heat conduction pattern at the cooling stage of laser joining of the joint of FIG. 1;

FIG. 11 is a thermographic image of a temperature distribution field of a heat conduction pattern at the initial heating stage of laser joining of the joint of FIG. 4;

FIG. 12 is a thermographic image of a temperature distribution field of a heat conduction pattern during the cooling phase of laser joining of the joint of FIG. 4;

FIG. 13 is a graphical illustration of the shear strength of the joints shown in FIGS. 1 and 4;

FIG. 14 is a schematic cross-sectional view of a metal component;

FIG. 15 is a schematic cross-sectional view of the metal component of FIG. 14 including a textured surface portion of the metal surface;

FIG. 16 is a schematic cross-sectional view of the metal component of FIG. 15 and a composite component being pressed together;

FIG. 17 is a schematic cross-sectional view of the metal component and the composite component of FIG. 16 after being pressed together, to form a non-planar joint interface therebetween; and

FIG. 18 is a schematic cross-sectional view of heating the joint interface of the metal component and composite component of FIG. 17 to form a melted zone in the composite component adjacent to the joint interface.

### DETAILED DESCRIPTION

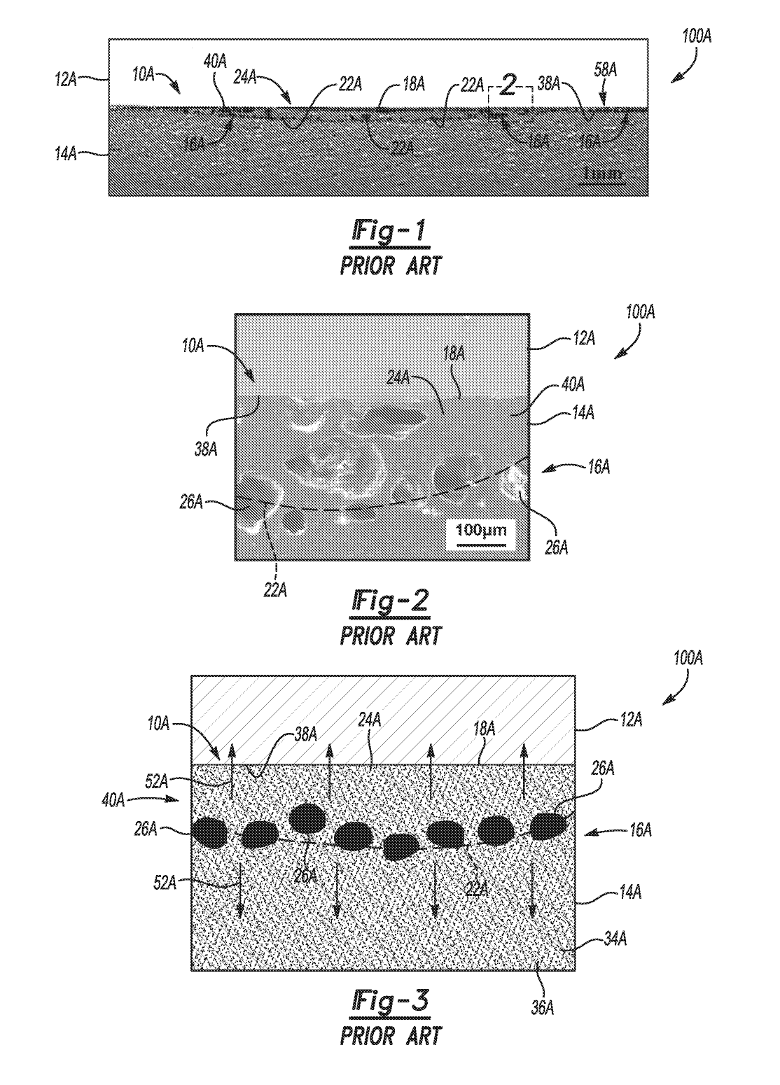

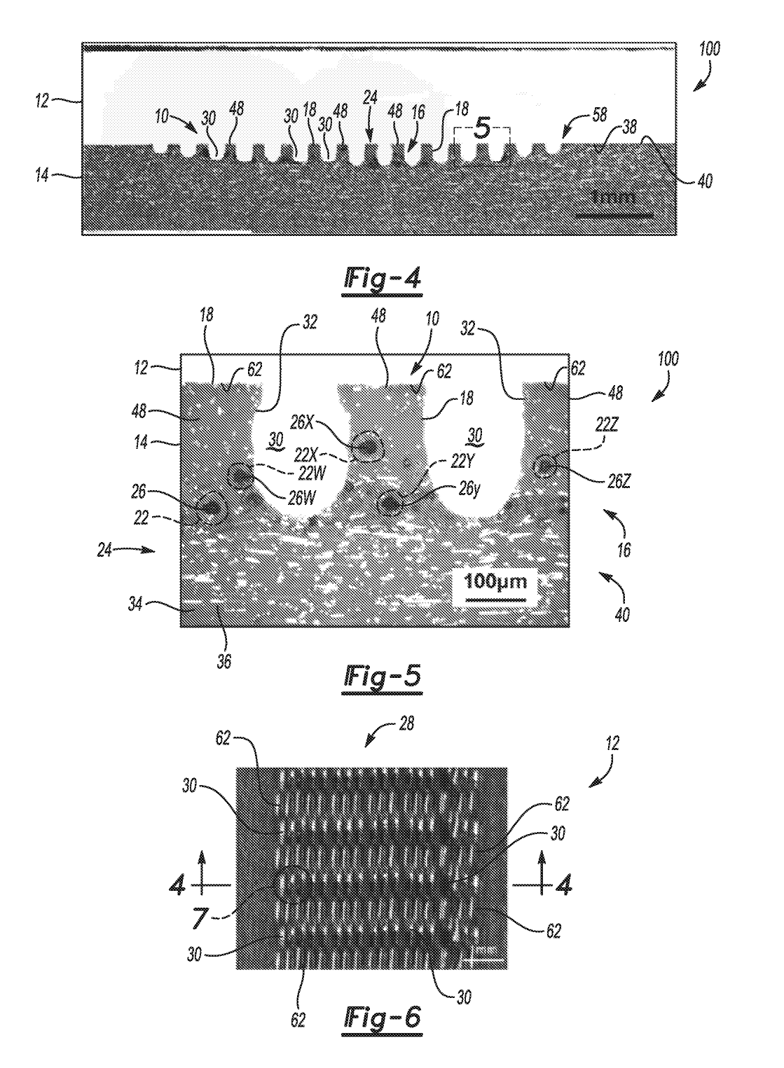

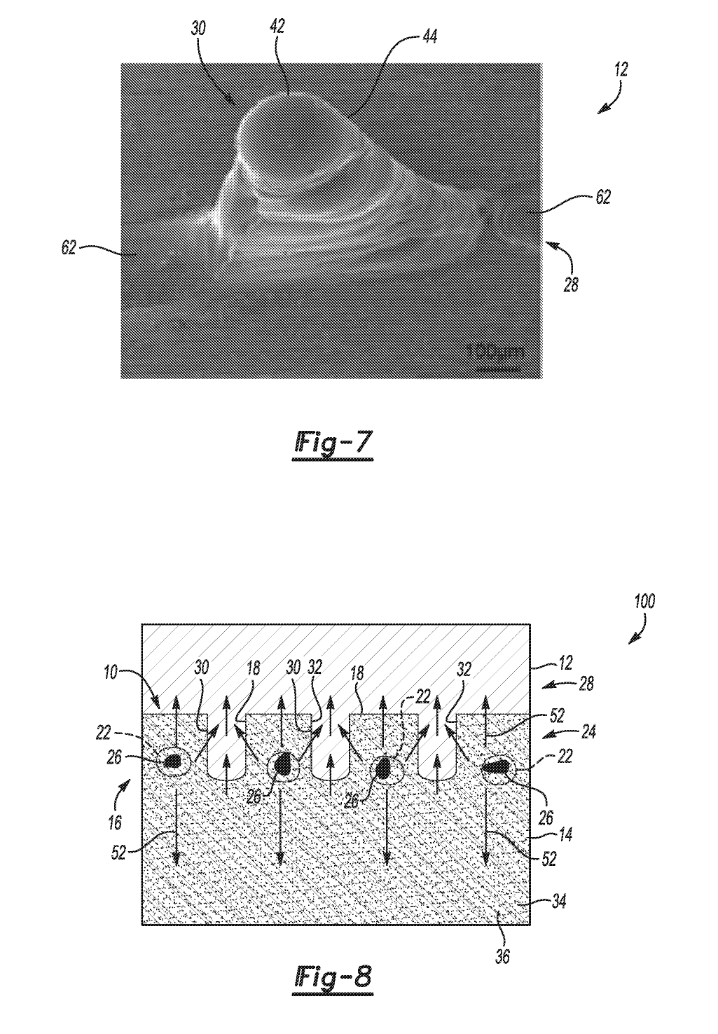

Referring to the drawings wherein like reference numbers represent like components throughout the several figures, the elements shown in FIGS. 1-14 are not to scale or proportion. Accordingly, the particular dimensions and applications provided in the drawings presented herein are not to be considered limiting. Referring to FIGS. 4, 5 and 8, a jointed member is generally indicated at 100. The jointed member 100 is formed by a method of joining described herein for forming a joint 10 between a metal component generally indicated at 12 and a composite component generally indicated at 14. The joint 10 is characterized by a non-planar joint interface 18 defined by a textured surface portion 28 of the metal component 12, and includes a solidified melted zone 24 which is characterized by a plurality of non-continuous solidification boundaries 22 and a discontinuous distribution of pores 26 which form a pattern of porosity 16. The textured surface portion 28 includes a plurality of protuberances 30 which are compressed into an interface surface portion 40 of the composite component 14 prior to heating to form a plurality of depressions 32 in the composite component 14, such that the surface area of the non-planar joint interface 18 includes the interface between surfaces 44, 46 (see FIG. 7, 15, 17) of the protuberances 30 and the depressions 32. Due to the relatively larger surface area of the non-planar joint interface 18 and the irregular heat conduction path 52 through the non-planar joint interface 18 of joint 10 shown in FIGS. 4, 5 and 8, as compared with relatively smaller surface area of the planar joint interface 18A and the regular heat conduction path 52A of the joint 10A shown in FIGS. 1-3, melting and cooling of the composite material at the joint interface 18 is performed more efficiently, e.g., in less time, and with less decomposition of the matrix material 34 during heating, resulting less entrapped gas and a distribution of porosity 16 characterized by fewer and smaller pores 26 more randomly dispersed in the solidified melted zone 24, relative to the joint 10A illustrated by FIGS. 1-3. The relative differences in the size and distribution of porosity 16 formed between a joint 10A formed with a generally planar joint interface 18A and the joint 10 described herein and formed with a non-planar joint interface 18 are shown by comparison of the metallographic image of FIG. 1 showing joint 10A and the metallographic image of FIG. 4 showing joint 10 of the present disclosure at the same magnification, and by comparison of the metallographic image of FIG. 2 showing joint 10A and the metallographic image of FIG. 5 showing joint 10 of the present disclosure at the same magnification.

During cooling of the melted zone 24, the irregular heat conduction pattern 52 through the non-planar joint interface 18, illustrated by arrows 52 shown in FIG. 8, causes formation of multiple discontinuous solidification boundaries 22 within the joint 10 and between the protuberances 30. Due to the random dispersion of relatively smaller pores 26 in the solidified melted zone 24 of joint 10 as compared with joint 10A, the effective cross-sectional area of the joint 10 formed with a non-planar joint interface 18 is greater than that formed in joint 10A shown in FIGS. 1-3, and the propensity, e.g., the tendency, for crack propagation is reduced due to the formation of multiple discontinuous solidification boundaries 22 and the absence of a continuous solidification boundary 22A. As such, under a loaded condition, for example, during tensile shear testing, crack propagation in the joint 10 is suppressed and/or interrupted by protuberances 30 protruding from the textured surface portion 28 into the solidified melted zone 24, by the formation of multiple and discontinuous solidification boundaries 22, and by a discontinuous pattern of porosity 16, such that the shear strength S_{T} and elongation E_{T} of the joint 10 formed at the non-planar joint interface 18 by the method disclosed herein is relatively higher than the shear strength S_{A} and elongation E_{A} of the joint 10A shown in FIGS. 1-3 and having a generally planar joint interface 18A. For example, FIG. 13 shows a graphical illustration of the relative shear strength behavior of the joints 10, 10A. Referring to FIG. 13, a tensile shear curve 64A shows performance of joint 10A having the planar joint interface 18A shown in FIGS. 1 and 2 under load testing, where the joint 10A fractures at a shear load S_{A} and elongation E_{A}, and a tensile shear curve 64 shows the performance of joint 10 having the non-planar joint interface 18 shown in FIGS. 4 and 5 under load testing, where the joint 10 fractures at a relatively higher shear load S_{T} and relatively greater elongation E_{T}.

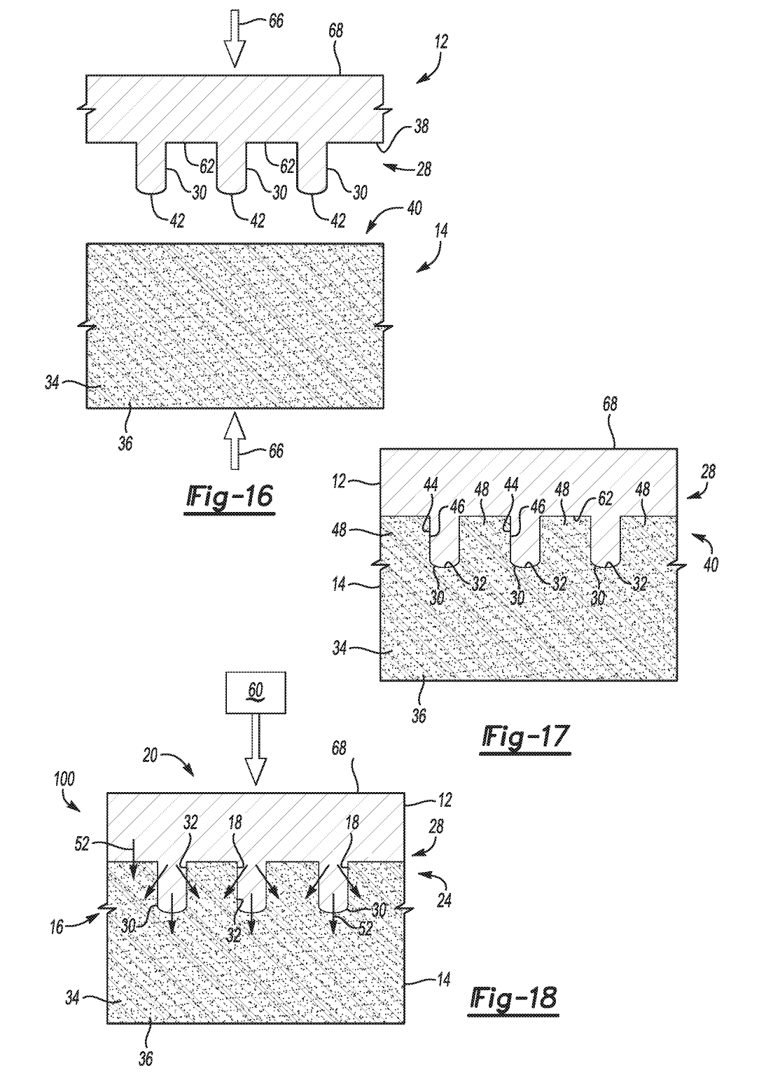

Referring again to FIGS. 4, 5 and 8, the jointed member 100 disclosed herein includes a metal component 12 having a metal surface 38 including a textured surface portion 28 and a composite component having an interface surface portion 40. The metal component 12 can be made of a metallic material such as steel alloys, aluminum alloys, titanium alloys and magnesium alloys, by way of non-limiting example. FIG. 6 shows the textured surface portion 28 formed on the metal surface 38, also shown cross-sectional view in FIGS. 4, 5, 8 and 15-18. The textured surface portion 28 includes a plurality of protuberances 30 protruding from the metal surface 38. In the example shown in FIGS. 4-6, the protuberances 30 are irregular in shape, and each protuberance 30 is separated from an adjacent protuberance 30 by a recess 62. FIG. 7 shows an example protuberance 30 having a protuberance surface 44 and terminating in a peak 42, where the height H of each protuberance 30 and the shape of the protuberance surface 44 and peak 42 are configured such that when the textured surface portion 28 of the metal component 12 is compressed into the interface surface portion 40 of the composite component 14, as shown in FIGS. 16 and 17, the protuberances 30 protrude into the interface surface portion 40 to compress the composite material to form a plurality of depressions 62 and intervening portions 48 in the composite component 14, and to form a non-planar joint interface 18 defined by the protuberance surfaces 44 in contact with depression surfaces 46 and intervening portions 48 in contact with recesses 62. In the non-limiting example shown in FIGS. 4-7, a laser is used to form the pattern of protuberances 30 and recesses 62 defining the textured surface portion 28. Other methods can be used for form the textured surface portion 28, for example, machining, stamping or roll-forming the metal surface 38 to form a plurality of protuberances 30, thus forming the textured surface portion 28. As shown in the non-limiting example in FIGS. 4-6, the protuberances 30 can be irregular or asymmetrical in shape, and can vary in height H (see FIG. 15), size, and configuration from one another. As shown in FIGS. 15-18, the protuberances 30 can be of a uniform size and shape, for example, as in a knurl or thread form defining a plurality of protuberances 30 and recesses 62. The examples shown are not intended to be limiting, and it would be understood that the textured surface portion 28 can be defined by a combination of protuberances 30 and recesses 62 which in combination increase the surface area of the non-planar joint interface 18 relative to the surface area of a planar joint interface 18A, and are of a configuration such that the protuberances 30 can be compressed into the interface surface portion 40 of the composite component 14 to form a plurality of depressions 62 and intervening portions 48 of composite material therein prior to heating the metal and composite components 12, 14 to form the joint 10. The configuration of the protuberances 30 and depressions 62 can define, for example, a peak and valley pattern, a sinusoidal pattern, a thread form such as a unified, acme, or buttress thread form, a rippled or wavelike pattern, or a combination of these.

The composite component 14 can be comprised of a polymer matrix material 34 in which a filler material 36 is dispersed. In a non-limiting example, the composite component 14 is made of a fiber-reinforced polymer (FRP), such as a carbon fiber-reinforced polymer (CFRP). The polymer matrix material 34 can be, by way of non-limiting example, a thermoplastic polymer such as polyester, vinyl ester, nylon, etc. The filler material 36 can be composed of, by way of non-limiting example, carbon fibers, an aramid such as Kevlar®, metallic fibers such as aluminum fibers, glass fibers, or ultra-high-molecular-weight polyethylene (UHMWPE) fibers. During the process of forming the joint 10, the textured surface portion 28 of the metal component 12 is compressed into an interface surface portion 40 of the composite component 14 to form the joint interface 18. The metal and composite components 12, 14 are then heated to a critical temperature T_{C} to melt the matrix material 34 of the interface surface portion 40 to create a melted zone 24 of composite material adjacent to the joint interface 18 and in contact with the textured surface portion 28. The metal and composite components 12,14 are cooled to solidify the melted zone 24 such that the solidified melted zone 24 bonds to the textured surface portion 28 at the joint interface 18. In a non-limiting example, the critical temperature T_{C} is defined by and/or corresponds to the melting temperature of the polymer material 34.

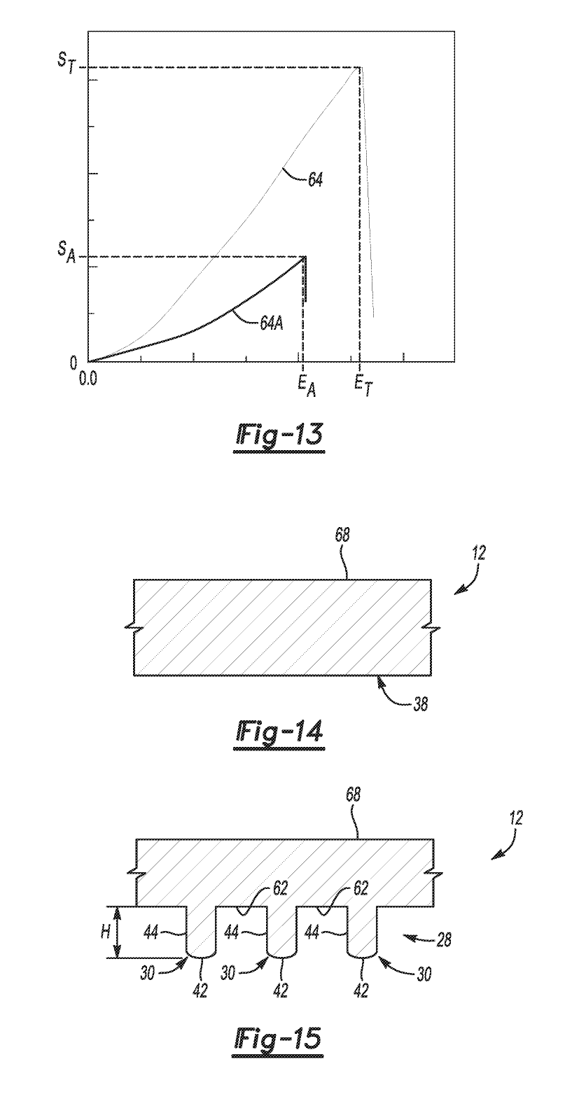

A method of forming the jointed member 100 shown in FIGS. 4-5 and 8 is illustrated by FIGS. 14-18 and FIG. 8. FIG. 14 shows the metal component 12 including an interfacing metal surface 38 which is textured to form the textured surface portion 28 shown in FIG. 15. The metal component 12 includes an exterior metal surface 68 generally opposing the portion of the interfacing metal surface 38 upon which the textured surface portion 28 is formed. The method of forming the jointed member 100 includes texturing a portion of the interfacing metal surface 38 to form the textured surface portion 28, as previously described herein, to form a plurality of protuberances 30 and recesses 62 defining the textured surface portion 28. Each of the protuberances 30 terminates in a peak 42 configured for protruding into the composite component 14.

The method includes, as shown in FIG. 16, placing the textured surface portion 28 in contact with the interface surface portion 40 of the composite component 14, and applying a compressive force 66 to at least one of the metal and composite components 12, 14 such that the textured surface portion 28 is compressed into the interface surface portion 40 to define a non-planar joint interface 18, as shown in FIG. 17. During compression of the textured surface portion 28 into the interface surface portion 40, the protuberances 30 protrude into and compress the composite material of the interface surface portion 40, forming depressions 62. The depression surface 46 of each respective depression 62 conforms to the protuberance surface 44 of each respective protuberance 30 protruding into the depression 62, thereby expanding and increasing the surface area of the joint interface 18 relative to the planar joint interface 18A shown in FIG. 3. As shown in FIGS. 4, 5 and 17, intervening portions 48 of composite material are compressed between adjacent protuberances 30 and into the recesses 62 between the adjacent protuberances 30, such that the interfaces between the respective recesses 62 and intervening portions 48, and the interfaces between the respective protuberance surfaces 44 and depression surfaces 46 collectively define the shape and surface area of the non-planar joint interface 18.

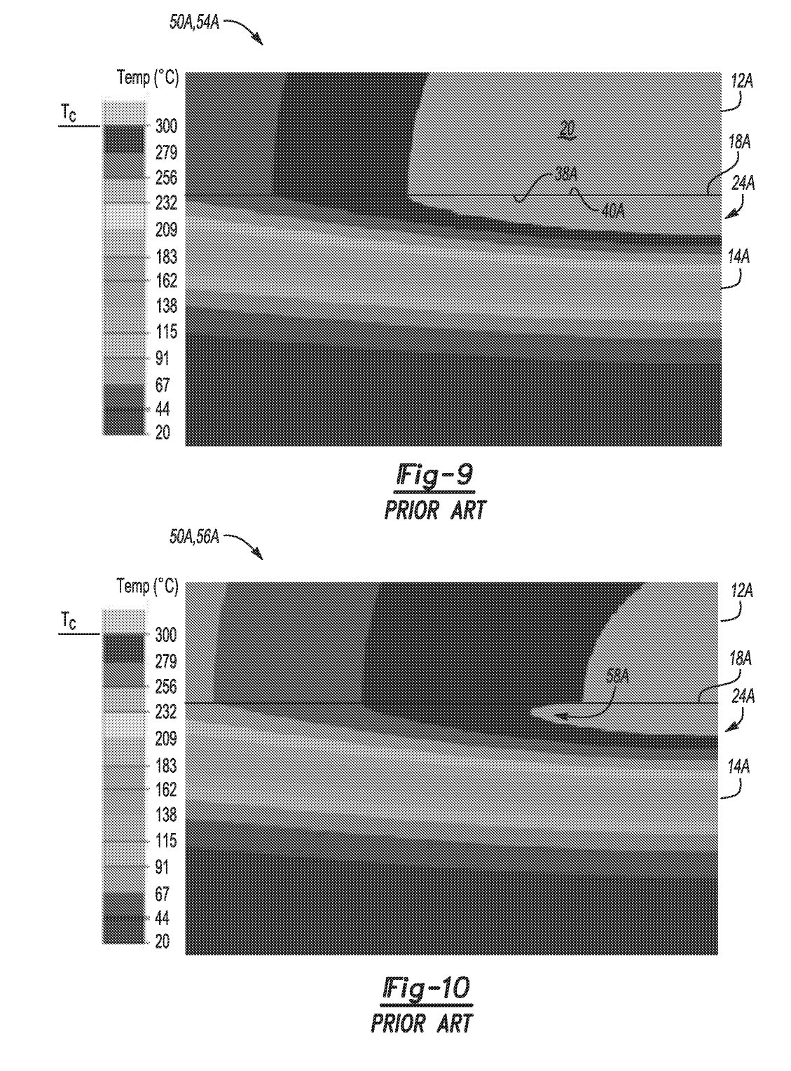

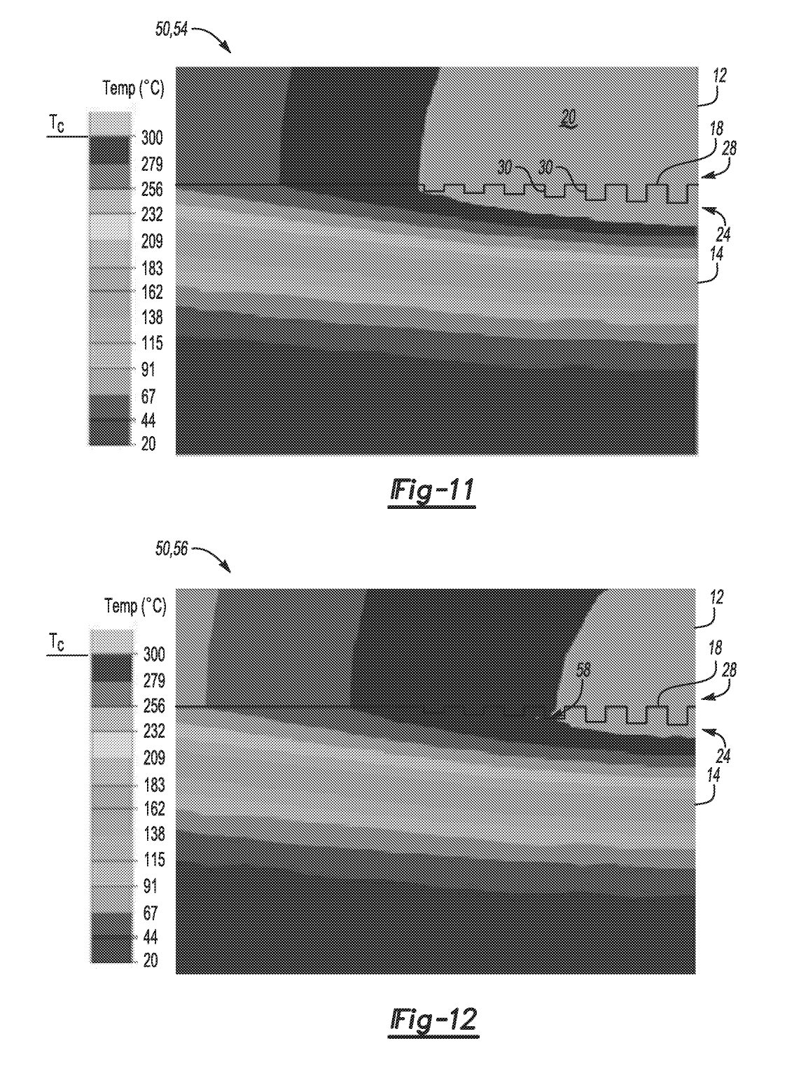

In the example shown in FIG. 18, after compressing the textured surface portion 28 into the interface surface portion 40 of the composite component 14 to shape the joint interface 18, a heat source 60, also referred to herein as a heating element 60, is directed at the exterior surface 68 of the metal component 12, to heat the metal and composite components 12, 14 at the joint interface 18 above a critical temperature T_{C} to create a melted zone 24 in the interface surface portion 40 immediately adjacent to the joint interface 18. The example shown in FIGS. 16-18 is non-limiting. For example, compression of the textured surface portion 28 into the interface surface portion 40, can occur prior to or during heating of the metal and composite components 12, 14. The heating element 60 can be a non-contact heating element 60 such as a laser beam for laser joining of the joint 10. Heat is conducted from the exterior surface 68 though the metal component 12 to the non-planar joint interface 18 to create a heated zone 20 in the metal component 12 as shown in the thermograph 54 of FIG. 11. During the heating cycle illustrated by FIG. 18, heat from the heating element 60 is conducted from the heated zone 20 via the textured surface portion 28 through the joint interface 18 to the interface surface portion 40 in an irregular, e.g., non-symmetrical, heat conduction pattern shown by arrows 52 in FIG. 18 to the interface surface portion 40, to heat the joint interface 18 above the critical temperature T_{C} and melt the polymer matrix material 34 in the melted zone 24. As illustrated by arrows 52 in FIG. 18, heat is conducted via the recesses 62 and protuberance surfaces 44 of the non-planar joint interface 18 into the intervening portions 48, which, due to the narrower width of the intervening portions 48 relative to the remainder of the composite component 14, are heated to the critical temperature T_{C} to form a melted zone 24 in relatively less time than is required to form the melted zone 24A adjacent to a planar joint interface 18A of joint 10A shown in FIGS. 1-4 and as further illustrated by the heat cycle thermograph 54A shown in FIG. 9. FIG. 3 shows a pattern of arrows 52A illustrating heat is conducted across the planar joint interface 18A in a regular, e.g., symmetrical, heat conduction pattern to an interface surface portion 40A which is coextensive with the heated zone 20, such that heat is conducted more slowly across the planar joint interface 18A having a smaller surface area than the non-planar joint interface 18, and is conducted into a melted zone 24A which has greater width relative to the width of each intervening portion 48 of joint 10.

Heating of the composite material above the critical temperature T_{C} causes gas generation during melting and decomposition of the polymer matrix material 34. Because the time required to heat the composite material of joint 10 to form the melted zone 24 adjacent to the non-planar joint interface 18 is relatively less than the time required to heat the composite material of joint 10A to form the melted zone 24A, due to increased heat conduction across the non-planar joint interface 18 having a relatively larger surface area than the planar joint interface 18A, due to the reduced thickness of the intervening portions 48, and due to the irregular heat conduction pattern 52 defined by the non-planar joint interface 18, the amount of entrapped gas generated during melting of the melted zone 24 of joint 10 is relatively less than the amount of entrapped gas generated during melting of the melted zone 24A of joint 10A shown in FIGS. 1-3. As such, relatively less gas is entrapped in the melted zone 18 of joint 10, and after solidification, the amount of porosity 16 formed in joint 10 is relatively less than the amount of porosity 16A formed in joint 10A, as shown by a comparison of the metallographic images of joint 10 shown in FIGS. 4-5 with the metallographic images of joint 10A shown in FIGS. 1-2.

After heating to create the melted zone 24, the metal and composite components 12, 14 are cooled as shown in FIG. 3, to solidify the melted composite material in the melted zone 24, bonding the composite material of the solidified melted zone 24 to the textured surface portion 28 to form the joint 10. Cooling occurs in joint 10 by conducting heat away from the non-planar joint interface 18 and the melted zone 24 in an irregular heat conduction pattern (shown by arrows 52 in FIG. 8) determined to a substantial extent by the plurality of protuberances 30 defined by the textured surface portion 28 and the non-planar configuration of the joint interface 18. Referring to the thermographs 50 shown in FIGS. 10 and 12, FIG. 10 shows a cooling cycle thermograph 56A for the joint 10A shown in FIGS. 1 and 2 at 234 milliseconds (ms) after cooling is initiated, and FIG. 12 shows a cooling cycle thermograph 56 for the joint 10 shown in FIGS. 4 and 5 at 192 milliseconds (ms) after cooling is initiated. The more rapid cooling and solidification of the melted zone 24 relative to the rate at which the melted zone 24A is cooled and solidified is shown by comparing the relative volumes of melted material (the material heated at or above critical temperature TO remaining at the respective times the thermographs 56, 56A were generated. A comparison of FIGS. 10 and 12 show joint 10 of FIG. 12 at 192 ms of cooling time has a smaller volume of melted material remaining in the melted zone 24 as compared with the larger volume of melted material remaining in the melted zone 24A of joint 10A shown in FIG. 10, at 234 ms of cooling time. Further, because of the more rapid cooling of the melted zone 24 of joint 10, minimal to no heat has accumulated at the periphery of the melted material, such that the rim portion 58 of joint 10 is minimal to non-existent, and, as shown in FIG. 4, minimal to no porosity 16 is formed at the periphery of the melted zone 28, e.g., adjacent to the joint interface 18 at the periphery of the textured surface portion 28. In contrast, the cooling cycle thermograph 56A of joint 10A shows a rim portion 58A of the melted zone 24A formed as a result of heat accumulation at the periphery of the melted material, due to the heat conduction pattern defined by the planar joint interface 18A of the joint 10A and shown by arrows 52A in FIG. 3. As shown in FIG. 1, due to the retarded cooling of the melted material at the rim portion 58A, porosity 16A forms at the joint interface 18A in the rim portion 58A. The porosity 16A is distributed along a continuous solidification boundary 22A which terminates at the joint interface 18A, such that the effective surface area of the joint 10A is reduced by the porosity 16A, and the joint 10A is relatively more susceptible to crack initiation at the rim portion 58A and crack propagation through the plurality of pores 26A distributed along the continuous solidification boundary 22A during loading of the joint 10A.

Referring again to FIGS. 4, 5 and 8, during cooling of joint 10, heat is rapidly conducted away from the intervening portions 48 via the protuberances 30 non-planar joint interface 18, such that, as the melted composite material solidifies, for example, at the depression surfaces 46, pockets of melted material remain in the partially solidified melted zone 24, interspersed in the intervening portions 48 and between the protuberances 30. As heat continues to be conducted away from the melted zone 24, the pockets of melted material solidify, such that at the last solidification of each pocket of melted composite material a last solidification boundary 22 is formed. As such, solidified melted zone 24 of the joint 10 is characterized by, e.g., includes, a plurality of discontinuous solidification boundaries 22.

A solidification boundary 22, as that term is referred to herein, is formed at and/or identifies the last solidification location at which melted material solidifies during solidification of the melted zone 24. The shape, size, and configuration of a solidification boundary 22, and the frequency and/or distribution pattern of solidification boundaries 22 found in a solidified melted zone 24 are determined at least in part by the heat conduction pattern which occurs during heating of the joint interface 18 portion of the composite component 14 to form the melted zone 24, and by the heat conduction pattern which occurs during cooling of the melted zone 24 to form a solidified melted zone 24. In the example shown in FIGS. 5 and 8, solidification of the pockets of melted material remaining at the end of the cooling cycle produces a plurality of solidification boundaries 22 which are defined by the last solidified composite material in each pocket, such that the solidification boundaries 22 shown in FIG. 8 can have a shape which may be generally one of a spheroid, ovoid, ellipsoid or similar shape.

Gas released during melting and decomposition of the matrix polymer migrates to the remaining pockets of melted material such that the solidification boundaries 22 formed by last solidification of the melted composite material in the pockets surround the pores 26 formed by the entrapped gas. As such, a respective solidification boundary 22 of a respective pocket can enclose a respective pore 26 formed by gas entrapped in the pocket and can be described as surrounding the respective pore 26. As shown in FIGS. 5 and 8, a solidification boundary 22W is formed around a pore 26W, a solidification boundary 22X is formed around a pore 26X, a solidification boundary 22Y is formed around a pore 26Y, a solidification boundary 22Z is formed around a pore 26Z, and so on, such that adjacent pores 26X, 26Y in the solidified melted zone 24 can each be surrounded by a respective solidification boundary 22X, 22Y such that the adjacent pores 26X, 26Y are separated from each other by their respective solidification boundaries 22X, 22Y, and the solidification boundaries 22X, 22Y are discontinuous with each other.

In the example shown in FIGS. 5 and 8, solidification boundaries 22W, 22X are formed in the solidified melted zone 24 such that at least one protuberance 30 is intermediate the solidification boundaries 22W, 22X, and such that the solidification boundaries 22W, 22X are discontinuous with each other. The discontinuity of the solidification boundaries 22 and the intermediate protuberances 30 act to suppress or interrupt crack propagation through the joint 10 during loading of the joint 10, contributing to, as shown in FIG. 13, a higher tensile shear strength S_{T} and higher elongation E_{T} of the joint 10 including a non-planar joint interface 18, relative to a joint 10A including a generally planar interface 18A.

The porosity 16, in the form of a plurality of pores 26 distributed in the solidified melted zone 24, is distributed in a relatively non-continuous pattern, as shown in FIGS. 4, 5, and schematically in FIG. 8. As shown in FIG. 5, the porosity formed during heating and cooling of the melted zone 24 can include pores 26W, 26X, 26Y, 26Z distributed in the solidified melted zone 24 such that one or more of the pores 26W, 26X, 26Y, 26Z are separated from at least another of the pores 26W, 26X, 26Y, 26Z by a protuberance 30, such that crack propagation between respective pores 26W, 26X, 26Y, 26Z can be interrupted by the respective protuberance 30 intermediate the respective pores 26W, 26X, 26Y, 26Z, reducing the tendency for crack propagation through the discontinuous porosity pattern 16 of the joint 10, and contributing to a relatively higher tensile shear strength S_{T} and relatively higher elongation E_{T} of the joint 10 as compared to joint 10A shown in FIGS. 1-3.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method of forming a jointed member, the method comprising:
providing a metal component having a first metal surface including a textured surface portion;
providing a composite component having an interface surface portion;
pressing the textured surface portion in contact with the interface surface portion such that the textured surface portion protrudes into the interface surface portion to form a non-planar joint interface defined by the textured surface portion; and
forming a joint at the non-planar joint interface between the metal component and the composite component by:
heating the joint interface above a critical temperature to form a melted zone in the interface surface portion immediately adjacent to the joint interface; and
solidifying the melted zone.

2. The method of claim 1, wherein solidifying the melted zone further comprises forming a plurality of solidification boundaries in the solidified melted zone.

3. The method of claim 2, wherein the solidification boundaries are discontinuous.

4. The method of claim 2, wherein:
the textured surface portion defines a plurality of protuberances; and
pressing the textured surface portion in contact with the interface surface portion further comprises:
pressing the plurality of protuberances into the interface surface portion to form a plurality of depressions in the interface surface portion;
wherein the non-planar joint interface is defined by the plurality of protuberances and the plurality of depressions.

5. The method of claim 4, wherein solidifying the melted zone further comprises:
conducting heat away from the melted zone in a heat conduction pattern defined by the textured surface portion; and
forming a plurality of pores in the melted zone;
wherein the plurality of pores are distributed in a discontinuous pattern corresponding to the heat conduction pattern.

6. The method of claim 4, wherein:
the plurality of solidification boundaries includes a first solidification boundary and a second solidification boundary; and
at least one protuberance is intermediate the first and second solidification boundaries.

7. The method of claim 4, wherein solidifying the melted zone further comprises:
forming a plurality of pores in the solidified melted zone;
the plurality of pores includes a first pore and a second pore distributed in the solidified melted zone such that at least one protuberance is intermediate the first and second pores.

8. The method of claim 4, wherein solidifying the melted zone further comprises:
forming a plurality of pores in the solidified melted zone;
wherein:
the plurality of pores includes a first pore bounded by a first solidification boundary and a second pore bounded by a second solidification boundary; and
the first and second pores are distributed in the solidified melted zone such that the first and second solidification boundaries are intermediate the first and second pores.

9. The method of claim 1, further comprising:
texturing the first metal surface to form a plurality of protuberances;
wherein the textured surface portion comprises the plurality of protuberances.

10. The method of claim 9, texturing the first metal surface using a laser.

11. The method of claim 9, wherein the protuberances are irregular in shape.

12. The method of claim 9, wherein the plurality of protuberances includes a first protuberance having a first height and a second protuberance having a second height;
wherein the first height and the second height are different heights.

13. The method of claim 1, wherein:
the composite material comprises a filler material dispersed in a polymer material; and
the critical temperature is defined by the melting temperature of the polymer material.

14. The method of claim 1, wherein:
the metal component further comprises an exterior metal surface; and
heating the joint interface above a critical temperature further comprises:
directing a non-contact heating element at the exterior surface such that heat is conducted via the textured surface portion to the interface surface portion.

15. The method of claim 14, wherein the non-contact heating element comprises a laser.

16. A jointed member comprising:
a metal component having a metal surface including a textured surface portion;
a composite component having an interface surface portion including a solidified melted area;
wherein the textured surface portion protrudes into the solidified melted area such that the solidified melted area conforms to the textured surface portion to define a non-planar joint interface; and
a joint formed at the non-planar joint interface between the metal component and the composite component.

17. The jointed member of claim 16, wherein the textured surface portion is defined by a plurality of protuberances protruding from the metal surface.

18. The jointed member of claim 17, wherein the protuberances are irregular in shape.

19. The jointed member of claim 17, further comprising:
a plurality of solidification boundaries formed in the solidified melted area;
the plurality of solidification boundaries comprising a first solidification boundary and a second solidification boundary; and
wherein at least one protuberance is intermediate the first and second solidification boundaries.

20. The jointed member of claim 17, further comprising:
a plurality of pores distributed in the solidified melted zone;
wherein the plurality of pores includes a first pore and a second pore distributed in the solidified melted zone such that at least one protuberance is intermediate the first and second pores.
